(19) United States
(12) Patent Application Publication
(10) Pub. No.: US 2007/0237904 A1
(43) Pub. Date: Oct. 11, 2007

(54) Powered painting pad

(76) Inventors: David C. Campbell, Bel Air, MD (US); Daniel Bone, Langley Moor (GB)

Correspondence Address: John Yun;Black & Decker Corporation, Mail Stop TW199, 701 E. Joppa Rd, Towson, MD, 21286, US

(21) Appl. No.: 11/731,948

(22) Filed: Apr. 2, 2007

Related U.S. Application Data
(63) Continuation of application No. PCT/US05/36188, filed on Oct. 6, 2005.

(51) Int. Cl. B05D 1/28

(52) U.S. Cl. 427/428.01; 118/246

(57) ABSTRACT

The present invention is directed to a battery powered paint pad having a platen orbitally driven by the motor. The oscillatory distance and speed of the platen is optimized to achieve superior painting results. This is because high platen distance can cause wandering or lurching, while high orbital speed can cause the paint to splatter. A paint pad is replaceably attached to the platen.

### BACKGROUND OF INVENTION

Painting is a labor-intensive and time consuming task, often performed by non-professionals in their home or business. A variety of products exist to accomplish various painting tasks and help alleviate some of the work involved in painting. For example, paint can be applied using brushes, rollers, bristled pads, powered sprayers, etc. Some of these methods are not suited for controlled accurate paint application, and the methods that are suitable for more precision application often do not provide smooth or even coverage without the inconvenience of frequent reloading of paint. Therefore, it would be advantageous to provide a powered painting pad that evenly applies paint accurately with minimal effort and paint reloading by the user.

### SUMMARY OF INVENTION

The present invention is directed to a power tool having a paint pad on an end thereof. The tool may be corded, but is preferably cordless. The tool can come in a variety of forms, but generally includes a housing for holding a battery and a motor, and includes a platen orbitally driven by the motor. The paint pad is replaceably attached to the platen.

The orbital motion provided by the tool is similar to that in orbit sanders, polishers or other similar devices. However, the present powered painting pad is designed with less overall platen travel distance per unit of time than these known devices to achieve superior painting results. Simply placing a painting pad on an orbit sander will not achieve the desired results because the vigorous orbital action will cause wandering or lurching of the pad relative to the work surface if the orbit speed is acceptable but the stroke distance is too large, or splattering of paint if the orbit stroke distance is acceptable but the orbit speed is too high. Additionally, large stroke distances can produce poor results when applying paint over a stencil pattern because the paint gets scrapped off as the pad moves outwardly away from the opening in the stencil.

Therefore, the present powered paint pad reduces the overall oscillatory distance traveled per unit of time of a typical orbit sander to apply a smooth and even coat of paint.

### BRIEF DESCRIPTION OF THE DRAWINGS

FIG. 1 shows an powered paint pad of the present invention;

FIG. 2 shows the powered paint pad of FIG. 1 with an extension handle attached thereto; and

FIG. 3 is a sectional view of a prior art platen.

### DETAILED DESCRIPTION OF THE PREFERRED EMBODIMENTS

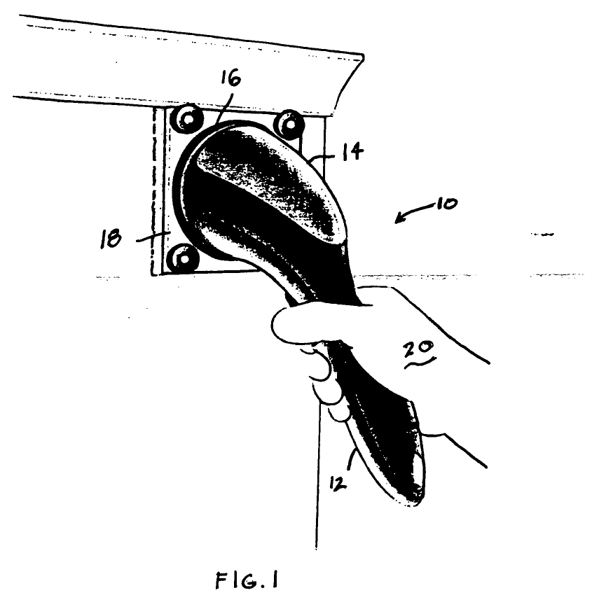

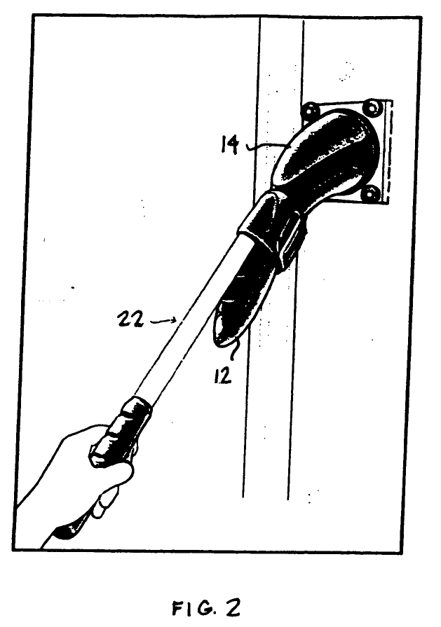

FIG. 1 shows a powered paint pad tool 10 of the present invention. The tool 10 has a rear handle portion 12 and a front head portion 14. Then handle portion can be gripped by the user to apply the paint, or as shown in FIG. 2, an pole 22 can be attached to the handle portion 12 to extend the reach of the tool 10.

The head portion 14 includes a platen 16 to which replaceable painting pads 18 are attached. The painting pads 18 can be attached to the platen using any known method, such as Velcro™. Although the platen 16 is shown to be circular and the painting pad 18 square, it should be understood that both the platen 16 and painting pad 18 can be any shape.

The housing includes a motor, a drive mechanism, and a power source such as batteries, that drive the platen in an orbital motion. This type of tool is well known in the art for such applications as sanding and polishing, and typically have an oscillation radius R of 0.031 inches or greater and oscillation speeds ranging from 2,500 to 20,000 rpm. However, these sanding and polishing tools that operate in the lower speed range have oscillation radii well in excess of 0.047 inches in order to function properly for their intended application.

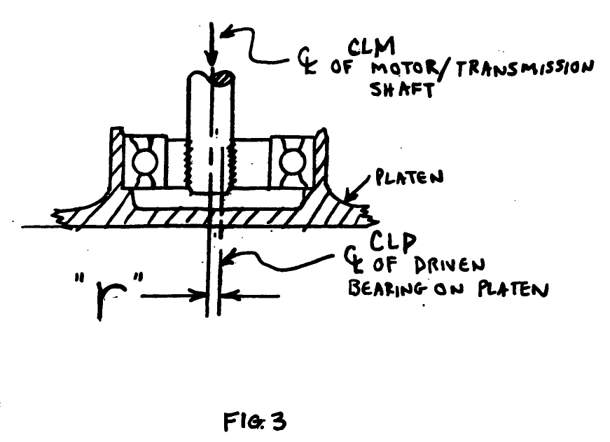

FIG. 3 shows a platen structure for an orbital tool. The oscillation radius R, which is directly related to the stroke distance, is defined as the distance between the centerline of the motor or transmission shaft CLM and the centerline of the driven bearing on the platen CLP. Using these numbers, a platen travel distance (PID) per unit time (t) can be measured, with PTD/t=2πR*rpm. All known sanding and polishing tools have a PTD/t of 1472 inches/min. or greater.

The present powered paint pad has a reduced oscillation radius R of 0.005 inches to 0.032 inches and a reduced oscillation speed of 2500 to 8000 rpm, the absolute extreme combinations of which produce a PTD/t in the range of 78 to 1608 inches/min. However, the practical upper limit of this range is approximately 1300 inches/min due to the problems cited above (paint splattering, tool wandering and lurching). Satisfactory painting results were achieved with a oscillation radius of 0.015 inches and a rpm of 6500 resulting in a PTD/t=160 inches/min. The reduced radius, in combination with the reduced speed, provide superior painting results without the disadvantages cited above.

Additionally, the motion of the platen is purely oscillatory, with no rotation. An anti-rotational feature is built into the mounting of the platen 16 to keep the platen 16 aligned with the main body of the tool 10. Rotation is removed so that non-circular paint pads can be used in corners, which would not be the case if rotational movement were permitted. The anti-rotation feature is common with orbit tools having square, rectangular or delta shaped (non-circular) platens, but is not found on orbital tools having circular platens. For example, orbit sanders and polishers with circular platens typically allow some rotational movement to be superimposed on the oscillating motion to reduce the creation of tiny circular swirls on the surface being sanded or polished.

Therefore, the present invention is directed to an orbital tool whose stroke distance and oscillation speed are optimized for painting applications and provides a powered painting tool that allows a user to paint more quickly and accurately with less effort.

Although a preferred embodiment has been disclosed, it should be noted that the description of the invention is merely exemplary in nature and, thus, variations that do not depart from the gist of the invention are intended to be within the scope of the invention. Such variations are not to be regarded as a departure from the spirit and scope of the invention.

1. A motorized powered paint tool comprising:
a housing having a handle to be gripped by a user;
a platen attached to the housing and driven in an orbital motion; an absorbent pad secured to the platen for applying paint to a surface; and
wherein the platen travel distance per unit time is less than 1472 inches per minute.

2. The powered paint tool as claimed in claim 1, wherein the platen travel distance per unit time is less then 1300 incher per minute.

3. The powered paint tool as claimed in claim 1, wherein the oscillation radius is between 0.005-0.032 inches.

4. The powered paint tool as claimed in claim 1, wherein oscillation speed is between 2500-8000 rpm.

5. The powered paint tool as claimed in claim 1, wherein the oscillation radius is between 0.005-0.032 inches and the oscillation speed is between 2500-8000 rpm.

6. The powered paint tool as claimed in claim 1, wherein the platen has no rotational movement.

7. A method of applying paint to a surface using an battery powered orbital tool comprising:
providing an orbital tool having a handle to be gripped by a user, the tool having a platen having an absorbent pad, and the platen having a travel distance per unit time is less than 1472 inches per minute;
soaking the absorbent pad with paint; and
applying the paint onto a surface.

8. The method of applying paint to a surface as claimed in claim 7 wherein the platen has an oscillation radius between 0.005-0.032 inches and an oscillation speed between 2500-8000 rpm.

9. The method of applying paint to a surface wherein the platen has no rotational movement.
